(19) United States
(12) Patent Application Publication
(10) Pub. No.: US 2013/0013500 A1
(43) Pub. Date: Jan. 10, 2013

(54) Multi-Sided Disbursement Platform

(76) Inventors: Thomas Purves, Toronto (CA); Vijay Halepet, Foster City, CA (US)

(21) Appl. No.: 13/542,535

(22) Filed: Jul. 5, 2012

Related U.S. Application Data
(60) Provisional application No. 61/505,916, filed on Jul. 8, 2011.

(51) Int. Cl. G06Q 40/00

(52) U.S. Cl. 705/41

(57) ABSTRACT

A system and method are disclosed for making disbursements to one or more consumers via a disbursement platform. In accordance with an embodiment, a method can comprise receiving at a computer, a first request to make a first disbursement. The method can further comprise receiving at the computer, a second request to make a second disbursement, wherein the first and second disbursements are different. The method can additionally comprise normalizing the first and second disbursements; and loading a prepaid account with the normalized first and second disbursements.

### CROSS-REFERENCE TO RELATED APPLICATIONS

This application is a non-provisional of and claims priority to U.S. Provisional Patent Application No. 61/505,916, filed on Jul. 8, 2011, which is hereby incorporated by reference in its entirety.

### BACKGROUND

Many businesses provide disbursements, such as refunds and rebates, to consumers after certain transactions are performed on that consumer's account. For example, a consumer can receive a refund after a friend signs a contract with the consumer's service provider (e.g., cable TV) or a bank can issue rewards after a certain dollar amount is charged on a credit card.

Presently, when businesses provide these disbursements to a consumer, a large amount of processing is required to track the value of the disbursement and issue a check or prepaid debit card, such as shown in FIG. 1. The business 101 is required to then mail the check or card 102 to a consumer 103 each time that a disbursement is issued. Not only does this require additional manpower and processing power to provide a physical payment of the value to the consumer, but additional funding is often required in order to purchase the paper, printers, prepaid cards, envelopes and postage.

The aforementioned process is not only burdensome for the businesses issuing the disbursements, but also for the consumer who is required to conduct a transaction, e.g., go to a bank, to deposit a check and keep track of the check and/or numerous prepaid cards received.

Another problem with existing disbursement systems is that different businesses provide different types of disbursements. For example, one type of business may provide for a prepaid card as a disbursement, another business may provide a check as a disbursement, while another may provide a coupon as a disbursement.

In this case, a consumer may receive a number of different disbursements in different forms, and this is inconvenient for the consumer.

Accordingly, a system is needed which can streamline the disbursement process and which is convenient for both the issuing businesses as well as the consumers, reducing processing requirements and load on system resources.

### SUMMARY

A system and method are disclosed for making disbursements from one or more businesses to one or more consumers via a disbursement platform.

In accordance with an embodiment, a method can comprise receiving at a computer, a first request to make a first disbursement. The method can further comprise receiving at the computer, a second request to make a second disbursement, wherein the first and second disbursements are different. The method can additionally comprise normalizing the first and second disbursements, and loading a prepaid account with the normalized first and second disbursements.

Another embodiment of the invention is directed to a computer comprising a processor, and a computer readable medium coupled to the processor. The computer readable medium, comprising code, executable by the processor to implement a method. The method comprises: receiving at a computer, a first request to make a first disbursement; receiving at the computer, a second request to make a second disbursement, wherein the first and second disbursements are different; normalizing the first and second disbursements; and loading a prepaid account associated with a prepaid device with the normalized first and second disbursements.

Another embodiment of the invention is directed to a method of receiving disbursements from a plurality of businesses via a platform. The method comprises: receiving a notification from a platform indicating that the platform has received a first request to make a disbursement and a second request to make a first disbursement. The platform normalizes the first and second disbursements, and sends disbursement instructions in response to the notification wherein the disbursement instructions identify a prepaid account associated with a prepaid device to be loaded, and wherein the platform loads the prepaid account with the normalized first and second disbursements.

Another embodiment of the invention is directed to a computer comprising a processor, and a computer readable medium coupled to the processor. The computer readable medium comprises code, executable by the processor to implement a method. The method comprises: receiving a notification from a platform indicating that the platform has received a first request to make a disbursement and a second request to make a first disbursement, wherein the platform normalizes the first and second disbursements; and sending disbursement instructions in response to the notification wherein the disbursement instructions identify a prepaid account associated with a prepaid device to be loaded, and wherein the platform loads the prepaid account with the normalized first and second disbursements.

Another embodiment of the invention is directed to a method for making disbursements to one or more consumers via a platform. The method comprises: receiving at a computer, a first request to make a first disbursement; receiving at the computer, a second request to make a second disbursement, wherein the first and second disbursements are different; wherein the first and second requests share a common format; and loading a prepaid account with the first and second disbursements

Another embodiment of the invention is directed to a computer comprising a processor, and a computer readable medium coupled to the processor, the computer readable medium, comprising code, executable by the processor to implement a method. The method comprises: receiving at a computer, a first request to make a first disbursement; receiving at the computer, a second request to make a second disbursement, wherein the first and second disbursements are different; wherein the first and second requests share a common format; and loading a prepaid account with the first and second disbursements.

These and other embodiments of the invention are described in further detail below.

### BRIEF DESCRIPTION OF THE DRAWINGS

FIG. 1 illustrates a prior art disbursement system.

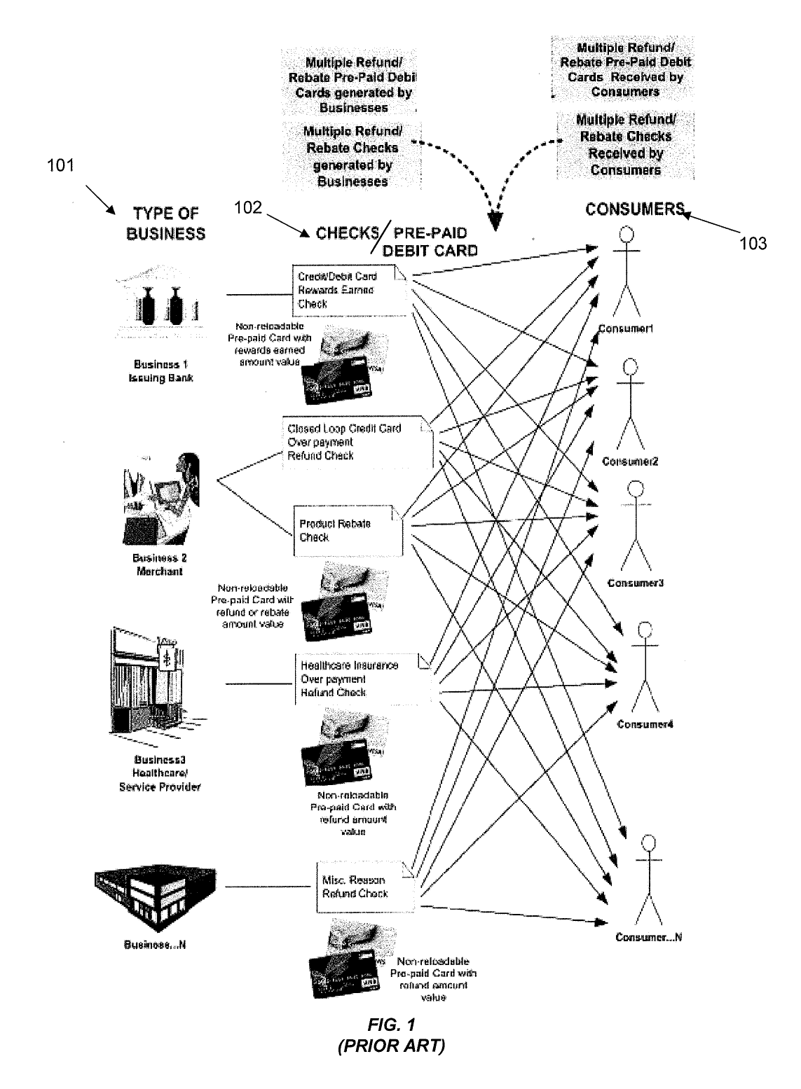

FIG. 2 illustrates a disbursement system in accordance with an embodiment of the invention.

FIG. 3 illustrates an exemplary multi-sided disbursement platform in accordance with an embodiment of the invention.

FIG. 4 illustrates an exemplary disbursement request message format in accordance with an embodiment of the invention.

FIG. 5 illustrates a system for providing a disbursement to a consumer on a multi-sided disbursement platform in accordance with an embodiment of the invention.

FIG. 6 illustrates a system for providing a disbursement to a consumer on a multi-sided disbursement platform in accordance with an embodiment of the invention.

FIG. 7 illustrates a method for providing a disbursement to a consumer on a multi-sided disbursement platform in accordance with an embodiment of the invention.

FIG. 8 illustrates an exemplary computer system used to access the disbursement platform in accordance with an embodiment of the invention.

### DETAILED DESCRIPTION

Embodiments of the present invention provide a centralized system in which disbursements, such as refunds and rebates, can be issued by a business and received by a consumer. The system includes a multi-sided disbursement platform, in which each consumer receiving a disbursement can have a registered account. The account can be linked to a single payment device, which is loaded each time that value has been added to the consumer account by a business. The consumer can be notified by the disbursement platform when additional value has been added to his/her account. The consumer can maintain the payment device and then easily use and reuse the payment device to conduct further transactions being equal to or less than the value on the payment device. The terms “platform,” “disbursement platform,” and “multi-sided disbursement platform” are used herein interchangeably.

In embodiments of the invention, the businesses (or computers operated by the businesses) can also be registered with the multi-sided disbursement platform in order to easily issue refunds and rebates to consumers through the disbursement platform as well as track already issued refunds and rebates. In some embodiments, each business can provide a commonly formatted disbursement request message to the platform, which includes the disbursement value and the consumer information, e.g., an identifier, such as a name, phone number, account number, etc. These commonly formatted disbursement requests can be formatted according to an application programming interface (API) published by the disbursement platform, a batch file format which specifies a format for submitting a plurality of requests at once for processing by the disbursement platform, or manually through a user interface which formats the requests accordingly to be compatible with the common format as information about the requests is entered through the user interface.

Additionally or alternatively, in other embodiments, businesses (or computers operated by the businesses) can provide requests using a plurality of different formats, and the disbursement platform can normalize the requests. For example if a business typically makes disbursements using paper checks, the business sends requests to a check processor according to a particular format. For example, the request may include an ABA (American Bankers Association) routing number, which is typically a nine-digit number. The check processor then processes the requests and issues checks to the appropriate consumers. Instead of sending these requests to the check processor, the business can send the same requests to the disbursement platform. The disbursement platform can then normalize the requests, which refers to the process of extracting disbursement information (e.g., the amount to be disbursed, the business' account or accounts from which to disburse, and identification information for the consumer to whom the disbursement is to be made), and then using this information to reformat the requests such that they can be processed by the disbursement platform and loaded to one or more accounts associated with the consumer. For instance, in the case of a check, the initial request may comprise an ABA routing number. This request is received by the platform. The platform can then cash the check by debiting the account of the business and the funds may be held in an account at the platform. The platform can then initiate an original credit transaction message to the entity (e.g., an issuer) that holds the prepaid account associated with a prepaid card that is used by the consumer to credit that account. The conversion from a checking type message to a payment card type original credit transaction message can be an example of a normalization process. In this example, processing savings are realized by avoiding paper check processing, and the business does not need to change its typical practices to take advantage of the disbursement platform. The disbursement platform can receive the value amount, e.g., money, from the business issuing the disbursement and can then identify a consumer account to which the value is added.

Although a check message to payment card type credit message has been described in detail, it is understood that other message conversions could also take place in other embodiments of the invention. For example, a message that requests a points or rewards credit could be normalized to an original credit transaction message.

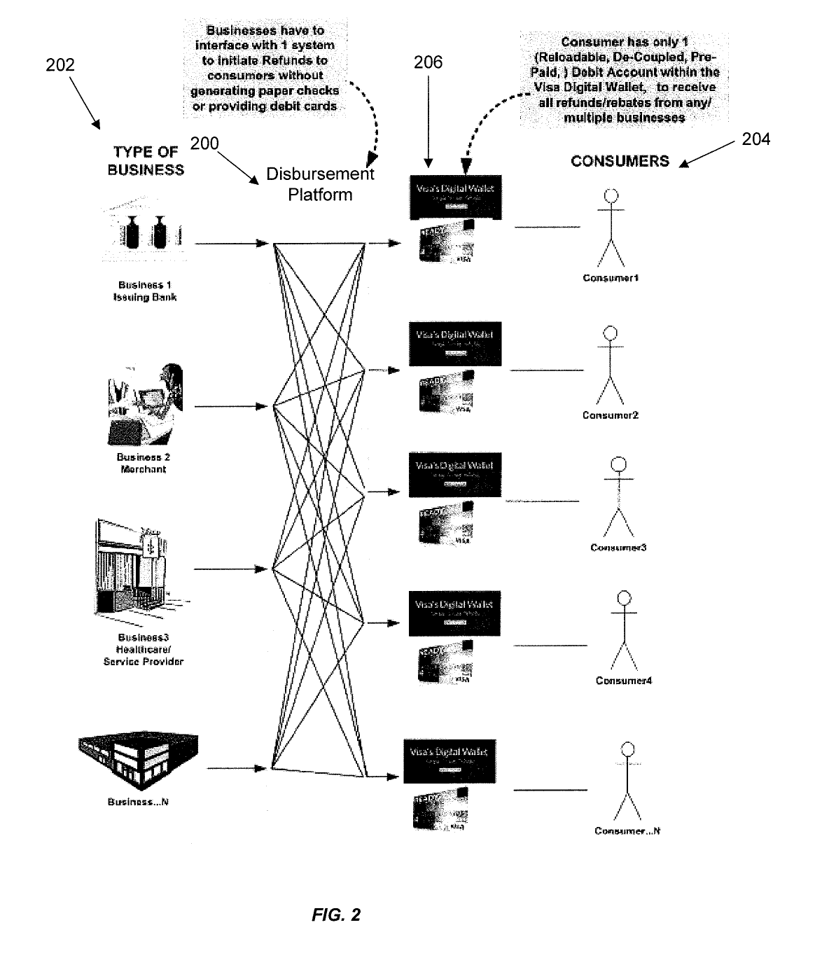

FIG. 2 illustrates a disbursement system which includes a disbursement platform, in accordance with an embodiment. As shown in FIG. 2, by using a disbursement platform 200, the method by which funds are delivered can be abstracted from how the business sends disbursement instructions. Each of the businesses 202 can interface with the disbursement platform to initiate disbursement to consumers 204. The platform 200 can make the disbursement 206 according to consumers' preferences, for example by transferring the appropriate funds to an existing credit or debit account using an original credit transaction (OCT), by issuing a new gift card, reloadable prepaid card or similar account, or by loading an existing/issuing a new virtual account in an electronic wallet. In embodiments of the invention, different disbursements provided by different businesses can be loaded into a single account such as a single prepaid account.

In embodiments of the invention, AFT and OCT messages can be used to debit and credit issuer accounts when, for example, funds are being transferred from a business account (e.g., a merchant account) to a different account (e.g., a prepaid account that will be used by the consumer). An OCT message is used to submit an original credit through VisaNet to the recipient's issuer. An AFT (Account Funding Transaction) is a transaction designed to supply funds to another account such as a Visa prepaid, debit, ATM card or on-line account, and is explained in more in U.S. Pat. No. 8,016,185, which is herein incorporated by reference in its entirety for all purposes.

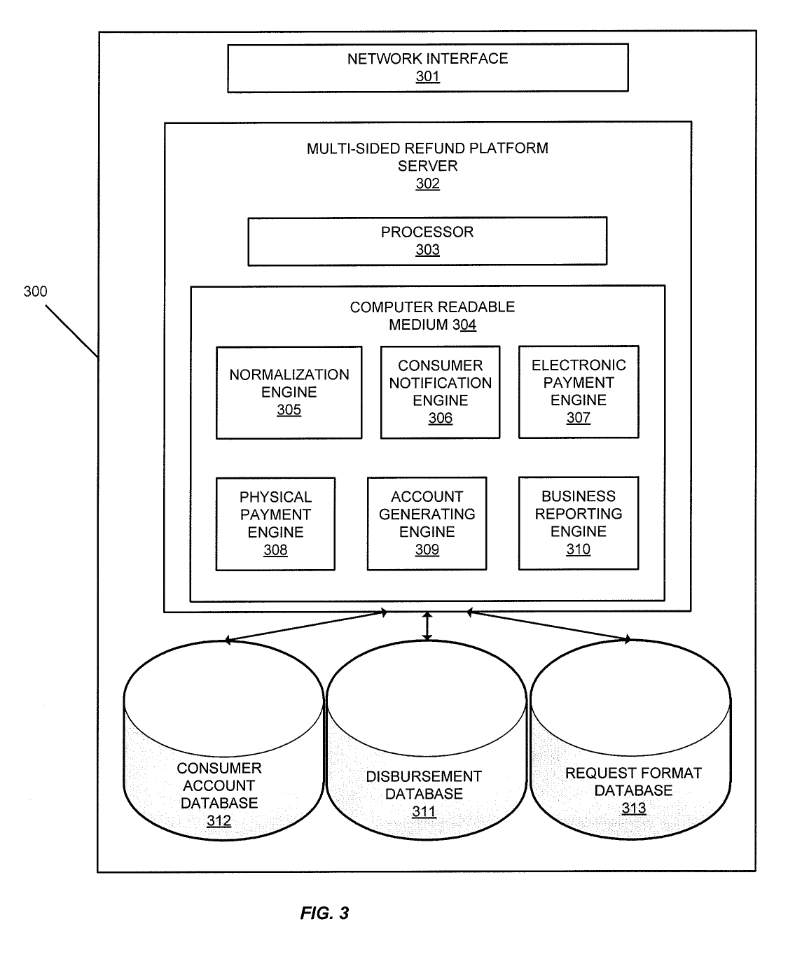

FIG. 3 illustrates a multi-sided disbursement platform, in accordance with an embodiment. The disbursement platform 300 can include a network interface 301, and a platform server 302 or cluster of platform servers. The interface 301 can be utilized to communicate between businesses and the disbursement platform and consumers and the disbursement platform. In accordance with an embodiment, these communications can be established through the Internet.

The platform server 302 can include a processor 303 to perform functions stored in the computer readable medium 304 of the server 302. The computer readable medium 304 can include a working memory, an operating system, and several different engines specific to the functions of the platform server 302. As shown in FIG. 3, the computer readable medium 304 can include a normalization engine 305, which receives the disbursement requests from the businesses and for each request determines the consumer information, the disbursement information and the business information from the message. The normalization engine 305 can additionally compare the consumer information extracted from each request to consumer account data stored in a consumer account database 312 to determine which users have registered with the platform. The normalization engine 305 can use any of the consumer information associated with a request to identify the associated consumer, e.g., the user's name, address, telephone number, account number, and other consumer information.

The platform server 302, can also include a consumer notification engine 306, which provides an alert or notification to a consumer when a disbursement request has been received or when new value has been added to the consumer's account if the consumer has provided standing instructions for disbursement. The notification can be provided electronically, such as through email or an SMS text message, or when the consumer conducts the next transaction with the prepaid refund card (e.g., if the consumer still has a positive balance on the card). In other embodiments, the consumer can be notified via physical mail or by telephone.

An electronic payment engine 307 can, for each request, verify that the business has funds available to cover the disbursement by communicating with the business' bank. Additionally, risk checks can be performed to determine whether the disbursement request is fraudulent. Once the business' funds have been confirmed and risk checks passed, the electronic payment engine 306 can transfer the funds, for example using an automated clearing house (ACH) transaction or OCT, and can load the disbursement value into the consumer's account in accordance with the consumer's instructions. A physical payment engine 308 can return disbursement requests for unregistered consumers to the business which sent the requests, or forward the requests to the business' preferred payment processor.

The computer readable medium 304 can also include an account generating engine 309, for consumers who have not created accounts with the platform. The account generating engine 309 can either be invoked by a consumer, who is registering with the disbursement platform, or a business which is issuing a disbursement to the consumer. The computer readable medium 304 of the platform server 302, can additionally include a business reporting engine 310. The business reporting engine 310 can provide refund reports to the businesses issuing the disbursements to the consumers. The reports can be generated on a consumer-by-consumer basis or a by-disbursement basis. In other embodiments, the reports can be generated on predetermined schedules, such as after one day, one week or one month.

The disbursement platform 300 also includes a plurality of databases to store consumer information and disbursement information. A disbursement database 311 can be used to track the status of each disbursement. This information can be utilized to generate the reports generated by the business reporting engine 310. The consumer account database 312 can be utilized by the normalization engine 305 as described above to identify registered and unregistered consumers and by the account generating engine 309, to store new consumer accounts. Additionally, consumer contact information which can be utilized to send the consumer notifications of new value added to an account can be stored in the consumer account database. Further, any standing instructions for processing disbursements can be stored in the consumer account database and linked to the consumer's account. A request format database 313 can store information about the format of different types of requests. This database can be used by the notification engine to determine which portions of a request to extract which correspond to consumer information, disbursement information, and business information.

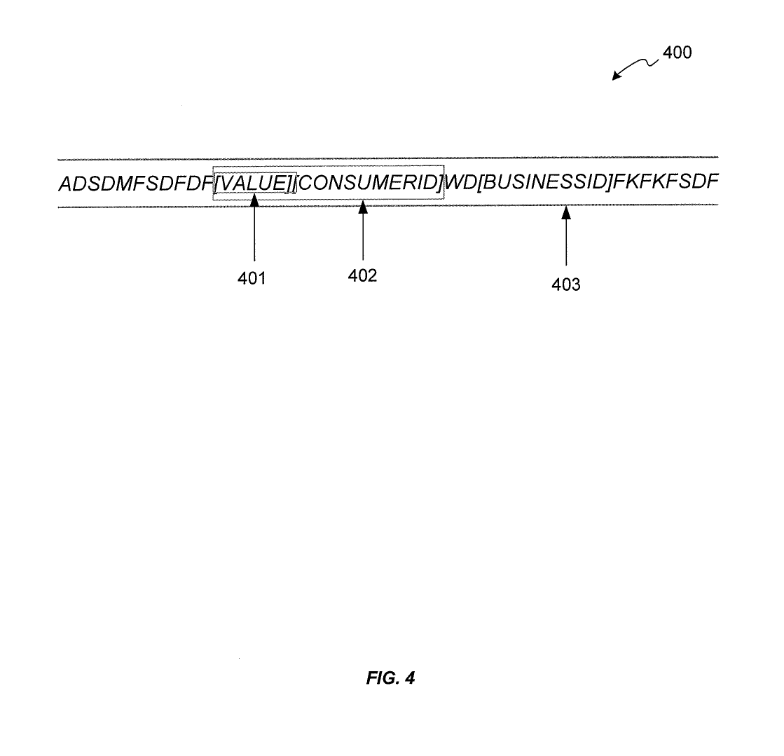

Referring now to FIG. 4, an exemplary disbursement request message format is provided. As shown, the original request message can include encrypted text as well as specific segments of letters, which can indicate the consumer information 402 and the disbursement value 401 to be provided to that consumer. Additionally, in some embodiments, the refund request message can be formatted to include business information 403. This can include an issued identifier, which can be utilized to easily locate the business on a database associated with the disbursement platform and related information, e.g., bank transfer information, associated with that particular business, and alternative disbursement processing instructions for use if the consumer does not have an account with the disbursement platform or cannot be reached to provide disbursement instructions.

In some embodiments, the disbursement platform can be responsible for normalizing a disbursement request and re-formatting a message to determine the information received from each individual business. The disbursement platform can include a request format database 313 which includes format information for a plurality of different request types. Using the request format database, the disbursement platform can identify the request format, and extract the consumer and business information from the request. For example, if a business ordinarily makes disbursements via paper checks, the business can continue formatting their disbursement requests in the same manner, and the disbursement platform will normalize the requests for use with the disbursement platform. The request format database can be extended by storing new format information for new request types. For example, if a business creates an account with the disbursement platform, they can upload format information for their disbursement requests.

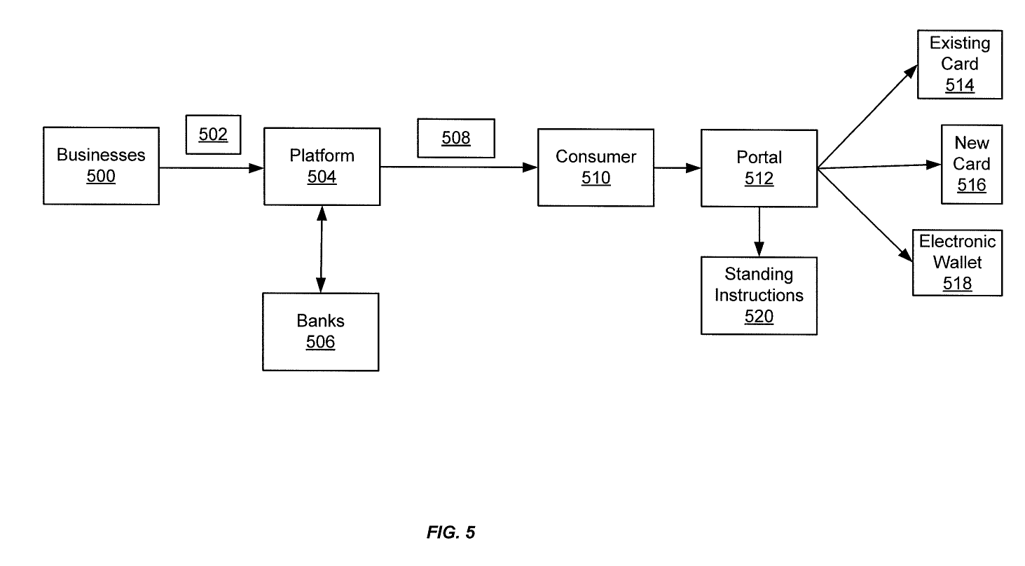

FIG. 5 illustrates a system for providing a disbursement to a consumer on a multi-sided disbursement platform 504 in an embodiment of the invention. As shown in FIG. 5, businesses 500 can send disbursement requests 502 to a disbursement platform 504. The disbursement platform 504 can extract disbursement information, consumer information and business information from the requests. The disbursement information can include a type of disbursement and a disbursement amount. The type of disbursement can include one of a rebate check, a prepaid card, and a coupon. The requests can be sent via an application programming interface (API) published by the disbursement platform, or in a batch file formatted according to a standard published by the disbursement platform. Additionally, requests can be manually submitted to the disbursement platform via a user interface. Each request sent via the API, batch file or user interface shares a common format which conforms to the standards published by the platform (e.g., the published API format or batch file format). This enables the platform to quickly and accurately identify and extract the disbursement, consumer and business information from the requests.

The disbursement platform 504 can communicate with banks 506 associated with the businesses 500 to confirm that sufficient funds are available to make the disbursements. For example, if a business sends 1000 disbursement requests to the disbursement platform for a combined $100,000 to be disbursed, the disbursement platform can confirm with the business' bank that the business has $100,000 available.

The platform can then transfer the appropriate funds from the bank via a financial network such as VisaNet using, for example, an original credit transaction (OCT). Alternatively, if the bank hosts the disbursement platform, then an “on us” credit can be issued. The disbursement platform can additionally perform checks on the consumer to comply with any existing regulations related to, e.g., terrorism or money laundering.

For each request, the disbursement platform can send a notification 508 to a consumer for whom the disbursement is requested, based on the consumer information extracted from the request. When the consumer 510 receives the notification, the consumer can access the disbursement platform via a web interface, such as a portal 512. The consumer can provide disbursement instructions via the portal 512. The disbursement instructions can identify the account associated with the consumer to which the funds are to be transferred, which can include one of an existing credit, debit or prepaid account 514, a new prepaid account 516, or an electronic wallet account 518. Funds can be transferred to the existing credit, debit or prepaid account 514 via a financial network such as VisaNet using an original credit transaction (OCT). More specifically, a payment processing network such as VisaNet can generate and/or route an account funding transaction message to an issuer bank associated with a business 500 and can also send an OCT message to the existing credit, debit, or prepaid account 514 so that funds are transferred from the business issuer account to the existing credit, debit, or prepaid account 514. An AFT message may be used to debit a business issuer account in some embodiments. In some embodiments, the existing credit, debit, or prepaid account 514 can be held by the platform 504 or by another issuer (not shown). A similar process could be used when a new account or card is issued, or when funds are transferred to an electronic wallet 518.

If the consumer requests a new prepaid account 516, the disbursement platform can connect to a prepaid issuing platform to issue the prepaid card to the consumer. In accordance with an embodiment, the new prepaid card can be a generic prepaid card or can be branded or customized based on the business which made the disbursement request. Additionally, the consumer can provide standing instructions 520 which the disbursement platform will automatically follow when a new disbursement is received. For example, the user can select an account to which all future disbursements will be made.

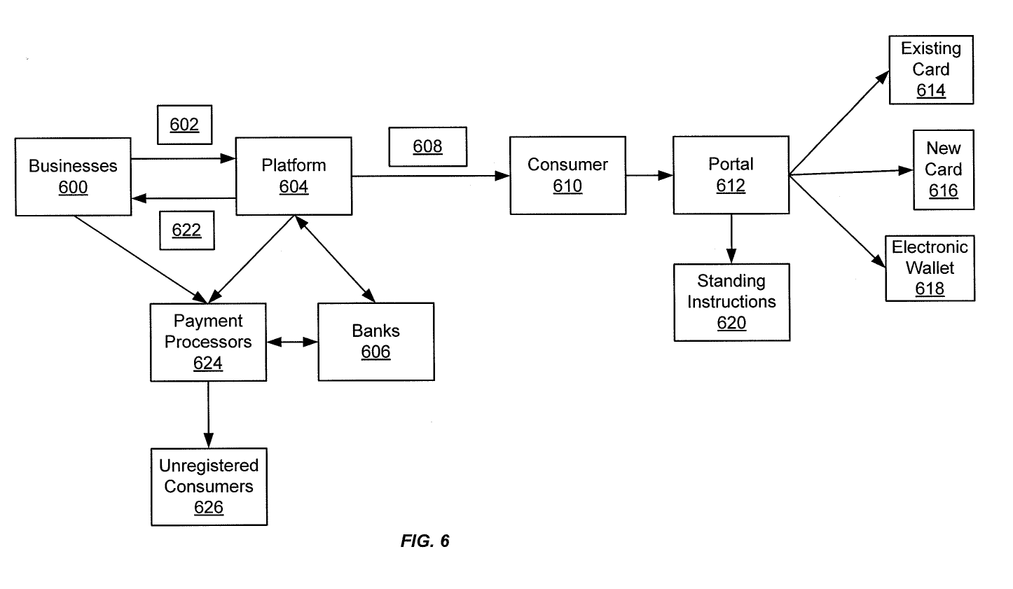

FIG. 6 illustrates a system for providing a disbursement to a consumer on a multi-sided disbursement platform in an embodiment of the invention. As described above, in the embodiment of FIG. 5, the disbursement platform can receive requests formatted according to standards published by the disbursement platform, such as an API or batch file format. Alternatively, as described in FIG. 6, each business 600 can continue to format requests as they had previously for their payment processors, but instead send those requests 602 to the disbursement platform 604 for processing. For example, if a business previously sent batch requests to a check processor who then issued paper checks to consumers, the business could instead send requests formatted the same way to the disbursement platform. This makes it easier for businesses to use the disbursement platform without changing their practices.

The disbursement platform 604 can normalize each request it receives using normalization engine 305. For example, if the disbursement platform receives a first request to send a refund check to a consumer, and a second request to send a prepaid rebate card to the consumer, each request will be formatted differently: the first request according to a check processor's format and the second request according to a prepaid card issuer's format. However, the normalization engine can normalize these different requests and make a single disbursement to the consumer, e.g. loading a prepaid card with a value equal to both disbursements.

The normalization engine can extract disbursement information, including consumer information and business information, from the disbursement requests. The normalization engine can compare the consumer information extracted from the disbursement requests to information stored in the consumer account database 312 to determine a list of requests associated with registered consumers. Any requests for which a registered consumer cannot be identified can be added to a list of requests associated with unregistered consumers.

For each request associated with a registered consumer, the disbursement platform 604 can confirm with the business' bank 606 that funds are available, and transfer the appropriate funds, as described above with respect to FIG. 5. The disbursement platform 604 can then send a notification 608 to the consumer 610 indicating that the consumer has one or more disbursements available. The consumer can log into a portal 612 or similar application and provide instructions for the disbursement(s) to be made to an existing credit, debit or prepaid account 614, to a new prepaid account 616 or to an account in an electronic wallet 618. The consumer 610 can also provide standing instructions 620 for how subsequent disbursements are to be made

The disbursement platform can process each request associated with an unregistered consumer in one of a plurality of ways. For example, the disbursement platform can return the list of requests associated with unregistered consumers 622 to the businesses 600 that made them. The businesses can then process those requests as they would have before, by sending the requests to their preferred payment processors 624 to issue paper checks, rebate cards, etc. to the unregistered consumers 626. Alternatively, the disbursement platform 604 can forward the requests associated with the businesses' payment processors 626 for processing.

In another alternative embodiment, the disbursement platform can create a new account for each unregistered consumer using the account generating engine 309 and load the disbursement to that account. The disbursement platform can then send notifications to the unregistered consumers using contact information received from the businesses, informing the unregistered consumers of their available disbursement and instructing them to register with the disbursement platform to receive their funds.

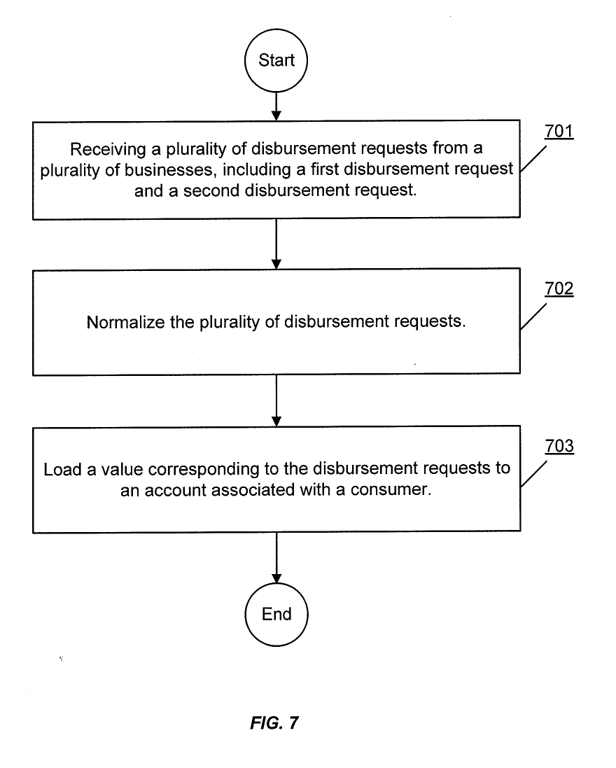

FIG. 7 illustrates a method for providing a disbursement from a business to a consumer through a multi-sided disbursement platform. In step 701, the disbursement platform can receive disbursement requests from a plurality of businesses. These requests can include more than one request for the same consumer, for example a first request and a second request for a particular consumer. The businesses can include, e.g., a bank, a service provider, a merchant, or any other business with which a consumer can conduct a transaction. The businesses can be registered with the disbursement platform, e.g., have accounts with which the businesses' employees can access the disbursement platform. The businesses can communicate with the disbursement platform via a communication channel which can include any form of communication, such as wireless communication, e.g., cellular or Wi-Fi, and a hard-wired connection, such as Ethernet. The businesses and the disbursement platform can communicate through a secure channel of communication through a medium such as the Internet. The business can utilize a portal, accessible using a personal computer, smartphone, laptop or other communication device. In some embodiments, the businesses can be provided with software including an application, which can be installed on a business communication device and opened to form a secure and direct communication with the disbursement platform.

In step 702, for each request, the disbursement platform can normalize the disbursement requests. Normalization can include identifying a consumer associated with that disbursement request. Each disbursement request can include consumer information, which can include any identifier, which enables the disbursement platform to determine if the consumer has an account on the disbursement platform. For example, the identifier can include any one or more of the consumer's name, phone number, address, account number, etc.

During normalization, if it is determined by the disbursement platform that the consumer is not registered with the disbursement platform, an account be made created for the consumer utilizing the consumer's information provided to the disbursement platform in the disbursement request. In some embodiments, the business can provide additional information about the consumer to the disbursement platform in order to create an account. For example, if the user's name and phone number were submitted in the query, the business could additionally provide the user's address, email address, birth date, gender, etc. Additionally, or alternatively, if the consumer does not have an account with the disbursement platform, the disbursement request can be returned to the business for processing. For example, the business can then submit the returned disbursement requests for consumers who do not have an account with the disbursement platform to a third party check processor to process the request and mail a paper check to those consumers. Additionally, or alternatively, the disbursement platform can forward the disbursement requests for consumers who do not have an account with the disbursement platform to the business' preferred disbursement or payment processor. The business can indicate the disbursement processor in each disbursement request received by the disbursement platform or the business can provide standing instructions associated with the business' account for processing disbursement requests for consumers who do not have an account with the disbursement platform.

During normalization, for those requests associated with consumers who are registered with the disbursement platform, disbursement information included in each disbursement request can be used to process the refund requests. The business can additionally transfer the value, e.g., monies, rewards points, etc. to the disbursement platform. The transfer can occur between an issuing bank associated with the business and an issuing bank associated with the disbursement platform. The transaction can be processed similar to a regular transaction, such as through an automated clearing house (ACH) and/or payment processing network, such as VisaNet.

In step 703, once the consumer information, refund information and refund value are received by the disbursement platform, the value can be loaded to the account of the consumer. The consumer can receive monetary refunds and/or rebates or other forms of values, such as rewards points. The value can be loaded onto a prepaid debit card, which can be obtained by the consumer through the business offering the refund. For example, if a loyalty program is joined, or refund is requested by a consumer, the consumer is often required to provide contact information in order to be a member of that program or receive a refund. The business can issue a card to the consumer once a refund is processed with the disbursement platform, e.g., if the business attempts to refund money to a consumer through the disbursement platform and the consumer account is created in the process of issuing the refund, the business can note the creation of the account and issue a prepaid card to the consumer. In other embodiments, the consumer may have an electronic wallet, which is capable of receiving any refunds, rebates or loyalty/reward points. The consumer can register the mobile wallet with the disbursement platform in order to receive such refunds and rebates directly and without the use of the prepaid card. In further embodiments, the prepaid card can be integrated with the consumer's existing credit, debit or stored-value card.

If the consumer has standing instructions for disbursement associated with their account, then the disbursement platform can provide a notification or alert to the consumer when a disbursement value is added to the consumer's account on the disbursement platform. The notification can be provided through any communication medium, such as mail, email, short message (SMS) text, a phone call, or a page. Once notified, the consumer can utilize the value within the refund account to conduct other transactions. For example, the consumer can utilize the prepaid card to purchase a product at a merchant location. Additionally, or alternatively, if the consumer has not set up standing instructions, the disbursement platform can send a notification to the consumer when disbursement funds are ready to be added to the consumer's account, requesting disbursement instructions. For example, the user may provide instructions that disbursements below a particular amount be added to a prepaid card, while disbursements over a particular amount may be added to a credit or debit account. The notification can include a link which when opened in a mobile or web browser can enable the consumer to provide standing instructions or one time instructions for processing the disbursement. If the user does not provide disbursement instructions in a predefined time period, or after a predefined number of notifications, the disbursement request can be returned to the business for conventional processing by a check processor, prepaid card issuer, or similar, or forwarded by the disbursement platform to the business' preferred processor.

As described above, in some embodiments disbursements may be made to a consumer's electronic wallet instead of, or in addition to, the consumer's credit, debit or prepaid account. Some features of an exemplary wallet can be found in U.S. Provisional Patent Application No. 61/466,409, entitled: “Electric Wallet”, by Edward Katzin, filed on Mar. 22, 2011, which is herein incorporated by reference in its entirety for all purposes. An electronic wallet may be used in a variety of transactions, including but not limited to eCommerce, social networks, money transfer/personal payments, mobile commerce, proximity payments, gaming, and/or the like. For example, users may engage in eCommerce via the electronic wallet for retail purchases, digital goods purchases, and utility payments. Users may also, for example, use the electronic wallet to purchase games or gaming credits from gaming websites, and transfer funds to friends via social networks. Further, for example, users may also use the electronic wallet on a smart phone for retail purchases, buying digital goods, NFC/RF payments at point of sale (POS) terminals. Thus, by making disbursements to a consumer's electronic wallet, the disbursed funds are made available for use by the consumer in a variety of transactions. An exemplary transaction using an electronic wallet is discussed below.

In an exemplary transaction involving an electronic wallet, a consumer may submit an indication to purchase or transfer funds. For example, the consumer may visit a merchant website (e.g., Facebook.com, Amazon.com, etc.), and request to purchase an item from the website, transfer funds to a friend, and/or the like. The merchant website may determine whether the electronic wallet is authorized on its website, and may provide a list of payment options. If the merchant is registered with an electronic wallet server, the electronic wallet server may authorize the merchant to collect consumer credentials for login to the electronic wallet, and the merchant website may prompt the consumer to login to the electronic wallet. Otherwise, the merchant website may request the consumer to provide payment details for alternative payment options (e.g., credit card, debit card, PayPal account).

The consumer may authorize submission of their wallet consumer credentials, such as, but not limited to a Wallet/User ID, a password, and/or the like. For example, the consumer may enter the Wallet/User ID and password into a pop-up window provided from the merchant website and/or electronic wallet server. In another example, the consumer may authorize the merchant website to provide the consumer credentials (e.g., previously stored in HTML5, cookies, etc.), to the electronic wallet server. In yet another example, the consumer may authorize the electronic wallet server, via a remote component running on the merchant website (e.g., a Java applet, etc.) to provide consumer credentials to the electronic wallet server for verification.

When the consumer submits consumer credentials to log into the electronic wallet, the merchant website may forward the consumer credentials and transaction details to the electronic wallet server, which may determine the validity of the consumer credentials. If the consumer's credentials are not valid, the electronic wallet server may deny the payment request and send a notification of denial to the merchant website. In other embodiments, if the consumer provided credentials are valid, the electronic wallet server may process payment from the electronic wallet. For example, the electronic wallet server communicates with the consumer's bank account associated with the electronic wallet and requests a fund transfer of an indicated amount. The electronic wallet server may then store a transaction record.

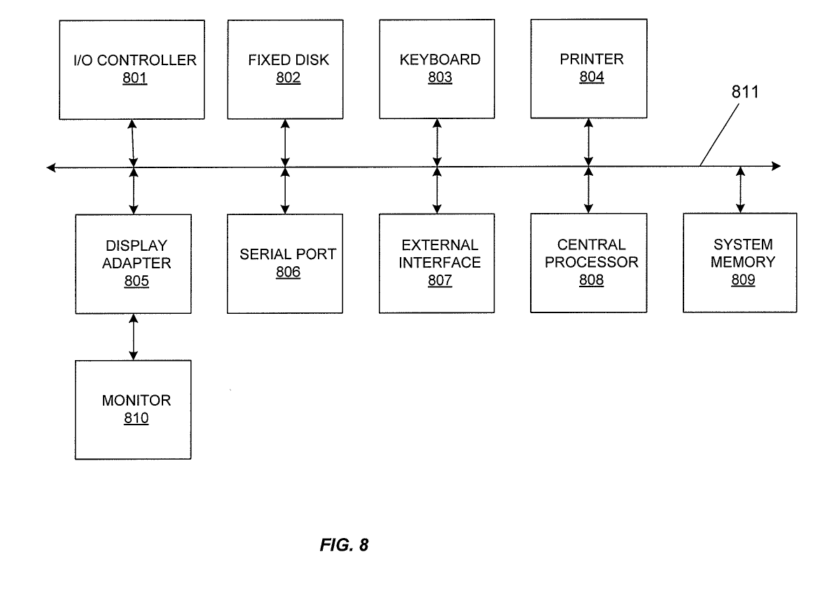

FIG. 8 illustrates an exemplary computer system 800, in which various embodiments may be implemented. The system 800 may be used to implement any of the computer systems described above (e.g., client computer, a server computer at the card association, a server computer at the issuer, a computer apparatus at the merchant, etc.). The computer system 800 is shown comprising hardware elements that may be electrically coupled via a bus 811. The hardware elements may include one or more central processing units (CPUs) 808, one or more input devices (e.g., a mouse, a keyboard 803, etc.), and one or more output devices (e.g., a display device 805, 810, a printer 804, etc.). The computer system 800 may also include one or more storage devices 802, 809. By way of example, the storage device(s) 802, 809 can include devices such as disk drives, optical storage devices, solid-state storage device such as a random access memory (“RAM”) and/or a read-only memory (“ROM”), which can be programmable, flash-updateable and/or the like.

The computer system 800 may additionally include a computer-readable storage media reader, a communications system (e.g., a modem, a network card (wireless or wired), an infra-red communication device, etc.), and working memory 809, which may include RAM and ROM devices as described above. The communication system can be connected through an external interface 807.

The computer-readable storage media reader can further be connected to a computer-readable storage medium, together (and, optionally, in combination with storage device(s) 808) comprehensively representing remote, local, fixed 802, and/or removable storage devices plus storage media for temporarily and/or more permanently containing, storing, transmitting, and retrieving computer-readable information. The communications system may permit data to be exchanged with the network and/or any other computer described above with respect to the system 800.

The computer system 800 may also comprise software elements, located within a system memory 809, including an operating system and/or other code, such as an application program (which may be a client application, Web browser, mid-tier application, RDBMS, etc.). It should be appreciated that alternate embodiments of a computer system 800 may have numerous variations from that described above. For example, customized hardware might also be used and/or particular elements might be implemented in hardware, software (including portable software, such as applets), or both. Further, connection to other computing devices such as network input/output devices may be employed.

Storage media and computer-readable media for containing code, or portions of code, can include any appropriate media known or used in the art, including storage media and communication media, such as but not limited to volatile and non-volatile, removable and non-removable media implemented in any method or technology for storage and/or transmission of information such as computer-readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

Embodiments of the invention provide for a number of advantages. For example, in embodiments of the invention, many different businesses may issue disbursements (e.g., rebates, refunds, etc.) and these can be handled at a universal platform. The platform may handle any data conversions necessary to debit appropriate business accounts while crediting a single prepaid account (or other account) used by a consumer. As a result, the consumer does not need to handle many different types of disbursements, and can use only one type of disbursement. Further, since fewer types of disbursements are provided to consumers, fewer computing resources are needed.

The above description is illustrative and is not restrictive. Many variations of the invention may become apparent to those skilled in the art upon review of the disclosure. The scope of the invention may, therefore, be determined not with reference to the above description, but instead may be determined with reference to the pending claims along with their full scope or equivalents.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method for making disbursements to one or more consumers via a platform, the method comprising:
receiving at a computer, a first request to make a first disbursement;
receiving at the computer, a second request to make a second disbursement, wherein the first and second disbursements are different;
normalizing the first and second disbursements; and
loading a prepaid account associated with a prepaid device with the normalized first and second disbursements.

2. The method of claim 1 wherein the first disbursement is in the form of an automated clearing house (ACH) payment and the second disbursement is in the form of load on a prepaid device.

3. The method of claim 1 wherein the prepaid device is a prepaid card.

4. The method of claim 3 wherein normalizing the first and second disbursements comprises normalizing the disbursements so that they are loaded to a single prepaid account associated with a single prepaid card.

5. The method of claim 1, further comprising:
sending a notification to a consumer indicating that the first request and second request have been received; and
receiving disbursement instructions from the consumer which identify the prepaid account.

6. A computer comprising a processor, and a computer readable medium coupled to the processor, the computer readable medium, comprising code, executable by the processor to implement a method comprising:
receiving at a computer, a first request to make a first disbursement;
receiving at the computer, a second request to make a second disbursement, wherein the first and second disbursements are different;
normalizing the first and second disbursements; and
loading a prepaid account associated with a prepaid device with the normalized first and second disbursements.

7. The computer of claim 1 wherein the first disbursement is in the form of an automated clearing house (ACH) payment and the second disbursement is in the form of load on a prepaid device.

8. The computer of claim 1 wherein the prepaid device is a prepaid card.

9. The computer of claim 3 wherein normalizing the first and second disbursements comprises normalizing the disbursements so that they are loaded to a single prepaid account associated with a single prepaid card.

10. The computer of claim 6, further comprising code executable by the processor to implement the steps of:
sending a notification to a consumer indicating that the first request and second request have been received; and
receiving disbursement instructions from the consumer which identify the prepaid account.

11. A method of receiving disbursements from a plurality of businesses via a platform, the method comprising:
receiving a notification from a platform indicating that the platform has received a first request to make a disbursement and a second request to make a first disbursement, wherein the platform normalizes the first and second disbursements; and
sending disbursement instructions in response to the notification wherein the disbursement instructions identify a prepaid account associated with a prepaid device to be loaded, and wherein the platform loads the prepaid account with the normalized first and second disbursements.

12. The method of claim 11 wherein the first disbursement is in the form of an automated clearing house (ACH) payment and the second disbursement is in the form of load on a prepaid device.

13. The method of claim 11 wherein the prepaid device is a prepaid card.

14. The method of claim 13 wherein normalizing the first and second disbursements comprise normalizing the disbursements so that they are loaded to a single prepaid account associated with a single prepaid card.

15. The method of claim 11, further comprising:
sending standing instructions which identify an account to which subsequent disbursements are to be loaded.

16. A computer comprising a processor, and a computer readable medium coupled to the processor, the computer readable medium, comprising code, executable by the processor to implement a method comprising:
receiving a notification from a platform indicating that the platform has received a first request to make a disbursement and a second request to make a first disbursement, wherein the platform normalizes the first and second disbursements; and
sending disbursement instructions in response to the notification wherein the disbursement instructions identify a prepaid account associated with a prepaid device to be loaded, and wherein the platform loads the prepaid account with the normalized first and second disbursements.

17. The computer of claim 16 wherein the first disbursement is in the form of an automated clearing house (ACH) payment and the second disbursement is in the form of load on a prepaid device.

18. The computer of claim 16 wherein the prepaid device is a prepaid card.

19. The computer of claim 18 wherein normalizing the first and second disbursements comprise normalizing the disbursements so that they are loaded to a single prepaid account associated with a single prepaid card.

20. The computer of claim 16, further comprising:
sending standing instructions which identify an account to which subsequent disbursements are to be loaded.

21. A method for making disbursements to one or more consumers via a platform, the method comprising:
receiving at a computer, a first request to make a first disbursement;
receiving at the computer, a second request to make a second disbursement, wherein the first and second disbursements are different;
wherein the first and second requests share a common format; and
loading a prepaid account with the first and second disbursements.

22. The method of claim 21, further comprising:
sending a notification to a consumer indicating that the first request and second request have been received; and
receiving disbursement instructions from the consumer which identify the prepaid account.

23. A computer comprising a processor, and a computer readable medium coupled to the processor, the computer readable medium, comprising code, executable by the processor to implement a method comprising:
receiving at a computer, a first request to make a first disbursement;
receiving at the computer, a second request to make a second disbursement, wherein the first and second disbursements are different;
wherein the first and second requests share a common format; and
loading a prepaid account with the first and second disbursements.

24. The computer of claim 23, further comprising code executable by the processor to implement the steps of:
sending a notification to a consumer indicating that the first request and second request have been received; and
receiving disbursement instructions from the consumer which identify the prepaid account.
